(19) United States
(12) Patent Application Publication
(10) Pub. No.: US 2013/0153609 A1
(43) Pub. Date: Jun. 20, 2013

(54) Miniature Football Helmet Liquid Bottle Pourer

(71) Applicant: Randal J. Carroll, Ketchum, ID (US)

(72) Inventor: Randal J. Carroll, Ketchum, ID (US)

(21) Appl. No.: 13/325,761

(22) Filed: Dec. 14, 2011

(51) Int. Cl. B67D 3/00

(52) U.S. Cl. 222/479; 222/78

(57) ABSTRACT

This embodiment is a sports memorabilia device where a molded polycarbonate, molded plastic, polycarbonate, fiberglass, aluminum alloy, metal, stainless steel or other sturdy material, miniature football helmet [001] body is incorporated with a uniquely designed liquid pourer [003] device adapted for attachment to a container of liquid. One thing that makes embodiment unique is it provides a liquid pouring tool incorporated with, but not limited to, a one-tenth scaled replica of an official football helmet with detailed color and graphics depicting the owner's favorite professional or collegiate team.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISK APPENDIX

Not Applicable

### BACKGROUND OF THIS EMBODIMENT

1. Field of this Embodiment

The present embodiment relates to bottle pourers and more particularly pertains to a new liquid pouring device incorporated with a miniature replica of an official football helmet with detailed color and graphics depicting the owner's favorite professional or collegiate team.

The present embodiment is in the sports memorabilia field. More particularly, and in its preferred intended use, the present embodiment relates to the technical field of portable liquid pouring devices.

2. Description of Prior Liquid Pourer Inventions

The use of bottle pourers is known, more specifically, bottle pourers heretofore devised and utilized are known to consist basically of familiar, expected and obvious structural configurations, notwithstanding the myriad of designs which have been developed for the fulfillment of countless objectives and requirements.

The prior use of liquid pourers includes having spouts inserted into a bottle with hoses connected to the spouts for allowing air into the bottle, and also includes pourers having a pouring element with a pouring duct. While these devices fulfill their respective, particular objectives and requirements, the aforementioned devices do not disclose a new miniature football helmet liquid bottle pourer.

### SUMMARY OF THIS EMBODIMENT

The general purpose of the present embodiment, which will be described subsequently in greater detail, is based on the fact that Americans are obsessed with sports. For those merchandisers who sell licensed sports apparel or sports memorabilia, the craze is big business, and it is growing fast. Collecting sports memorabilia is much like collecting art. People do it more because they love what they are buying, not so much because they expect it to grow in value. Although collectibles, and even sports items that no one considers at the time to be collectibles, can definitely appreciate. Conventional liquid pouring devices, such as those used in bars, restaurants and coffee shops are nondescript and only serve one function, to pour liquid from a container.

The present embodiment is a liquid pouring device designed to provide a sports memorabilia fan a liquid pouring tool (which has many of the advantages of the bottle pourers mentioned heretofore incorporated) with a miniature replica of an official football helmet with detailed color and graphics depicting the owner's favorite professional or collegiate team. None of the prior liquid pourers includes the combination of the elements of the present embodiment. There is none anticipated, rendered obvious, suggested, or even implied by any of the prior bottle pourers, either alone or in any combination thereof. There has thus been outlined, rather broadly, the more important features of the miniature football helmet liquid bottle pourer in order that the detailed description thereof that follows may be better understood, and in order that the present contribution to the art may be better appreciated. There are additional features of this embodiment that will be described hereinafter and which will form the subject matter of the claims appended hereto.

In this respect, before explaining at least one embodiment of this embodiment in detail, it is to be understood that this embodiment is not limited in its application to the details of construction and to the arrangements of the components set forth in the following description or illustrated in the drawings. This embodiment is capable of other embodiments and of being practiced and carried out in various ways. Also, it is to be understood that the phraseology and terminology employed herein are for the purpose of description and should not be regarded as limiting.

It is an object of the present embodiment to provide a new miniature football helmet liquid bottle pourer which has many of the advantages of the bottle pourers mentioned heretofore and many novel features that result in a new miniature football helmet liquid bottle pourer which is not anticipated, rendered obvious, suggested, or even implied by any of prior bottle pourers, either alone or in any combination thereof.

Still another object of the present embodiment is to provide a miniature football helmet liquid bottle pourer for easy pouring of liquids.

Still yet another object of the present embodiment is to provide a miniature football helmet liquid bottle pourer that pours freely while reducing aeration and dripping of the liquid from a bottle once pouring has stopped.

Even still another object of the present embodiment is the unique design of the pourer engine which connects the miniature football helmet liquid bottle pourer to the helmet and liquid emitting device such as but not limited to a bottle.

These together with other objects of this embodiment, along with the various features of novelty which characterize this embodiment, are pointed out with particularity in the claims annexed to and forming a part of this disclosure. For a better understanding of this embodiment, its operating advantages and the specific objects attained by its uses, reference should be made to the accompanying drawings and descriptive matter in which there are illustrated preferred embodiments of this embodiment.

### BRIEF DESCRIPTION OF THE DRAWINGS

FIG. 1 is a perspective view of a miniature football helmet liquid bottle pourer of the present embodiment;

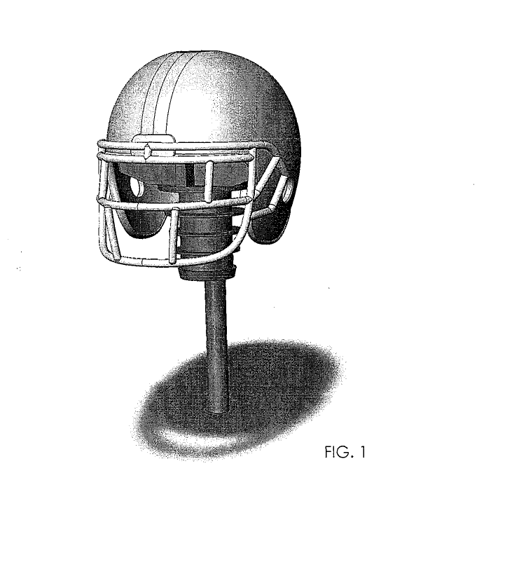

FIG. 1A is a perspective view of a miniature football helmet liquid bottle pourer, indicating the three main, integral parts of the present embodiment;

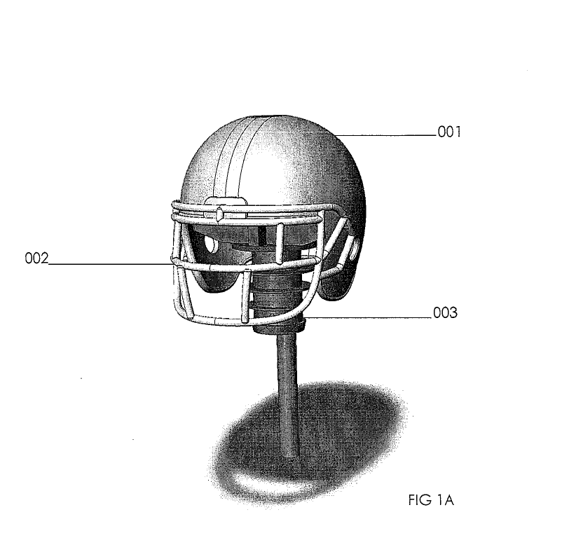

FIG. 2 is a side view of a miniature football helmet liquid bottle pourer of FIG. 1;

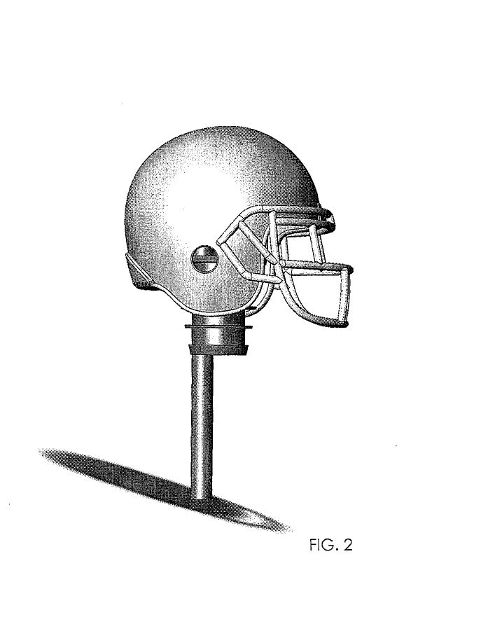

FIG. 3 is a front view of a miniature football helmet liquid bottle pourer of the present embodiment;

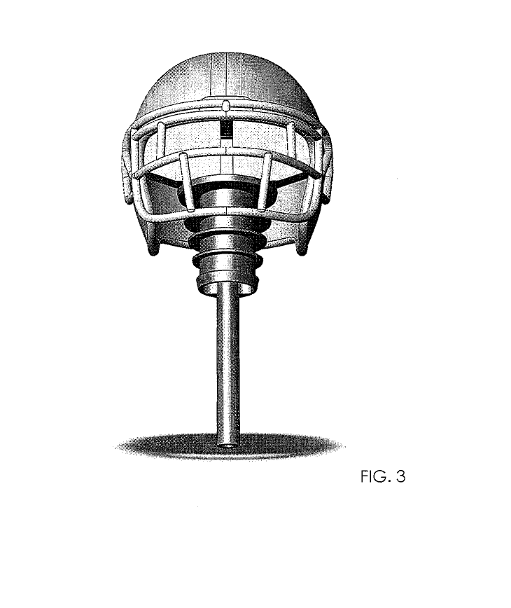

FIG. 4 is a cross section view of a miniature football helmet liquid bottle pourer of FIG. 2;

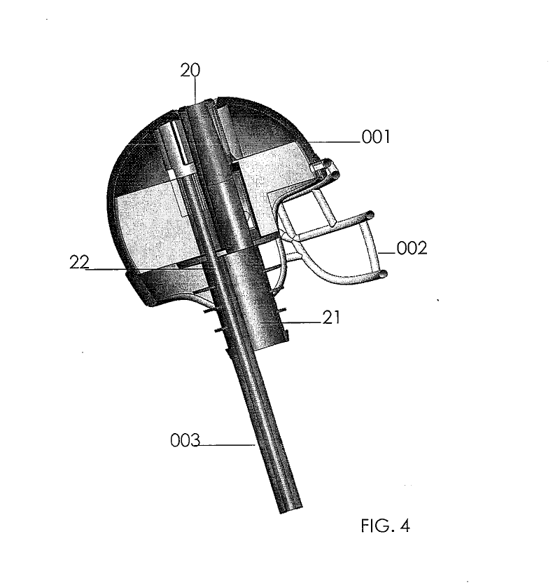

FIG. 5 is a top view of a miniature football helmet liquid bottle pourer of the present embodiment.

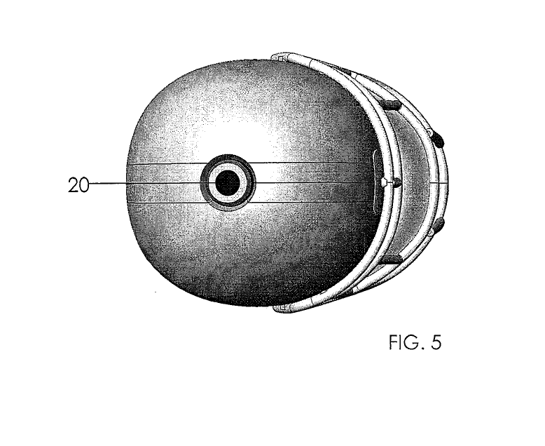

FIG. 6 is a rear view of a miniature football helmet liquid bottle pourer of the present embodiment.

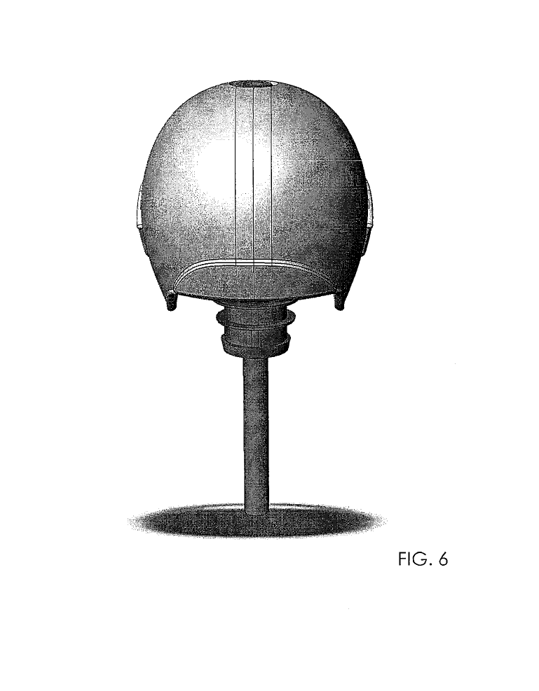

FIG. 7 is bottom view of a miniature football helmet liquid bottle pourer of the present embodiment.

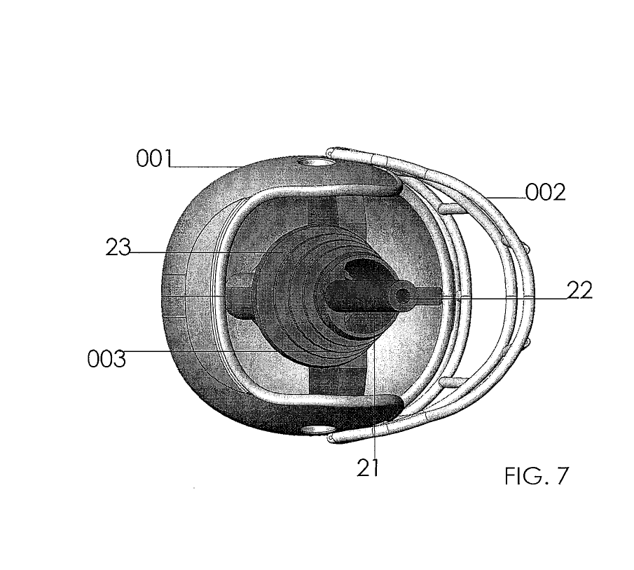

FIG. 8 is a transparent view of a miniature football helmet liquid bottle pourer of the present embodiment.

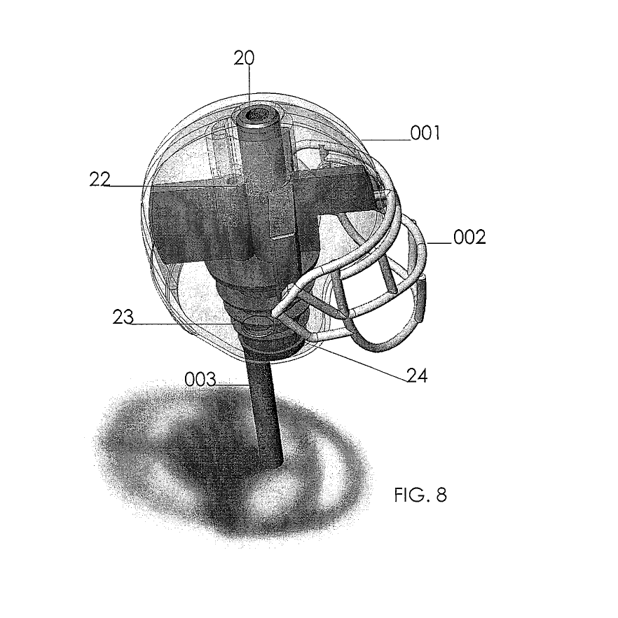

FIG. 9 is a pourer component view of a miniature football helmet liquid bottle pourer of the present embodiment.

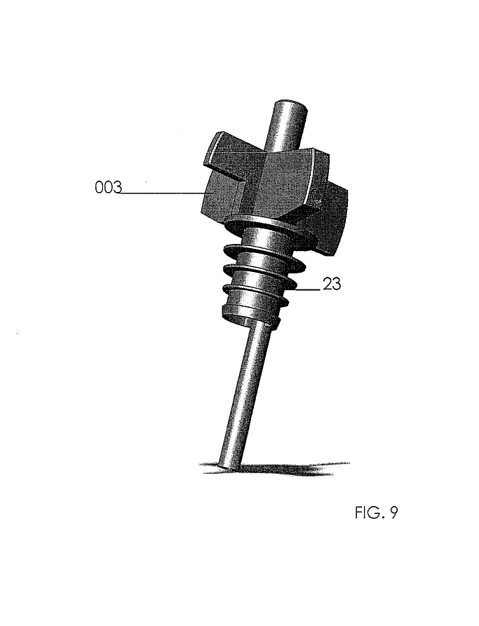

FIG. 10 is a pourer component top view of a miniature football helmet liquid bottle pourer of the present embodiment.

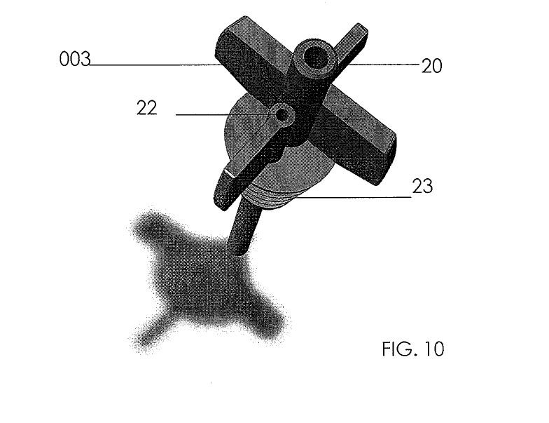

FIG. 11 is a helmet component view of a miniature football helmet liquid bottle pourer of the present embodiment.

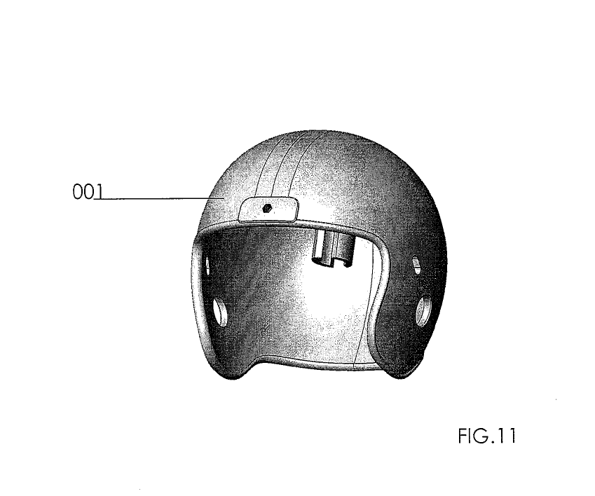

FIG. 12 is a facemask component view of a miniature football helmet liquid bottle pourer of the present embodiment.

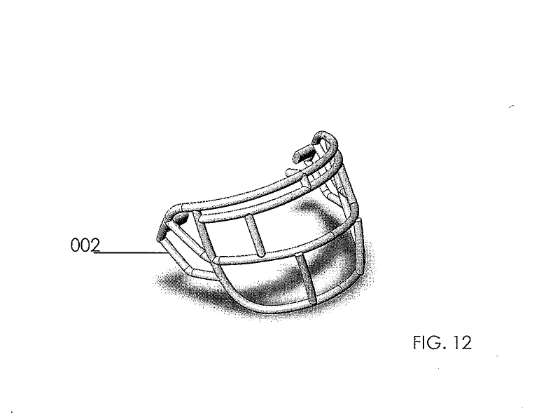

### DETAILED DESCRIPTION OF THIS EMBODIMENT

The present embodiment is a functional memorabilia device in the form of a miniature replica football helmet [001] of approximately, but not limited to, one-tenth the size of an official football helmet [001] with a pouring spout assembly [003] adapted to be employed in a pour opening of a container such, but not limited to, as a bottle, said assembly comprising: a pouring passage [003] defined through said assembly for conducting liquid out from said container. Replica helmet [001] body: molded plastic, polycarbonate, fiberglass, aluminum alloy, metal, stainless steel, or other sturdy material, preferably polycarbonate formed in shape of approximate, but not limited to, one-tenth football helmet [001] with hole in top (20) (slightly larger than the diameter of the tip of the liquid pourer [003] device). Helmet [001] body has interference fit for the uniquely designed liquid pourer [003] device to dispense liquid once the entire assembly is in an inverted position. Replica facemask [002] rubber, vinyl or plastic-coated metal, metal, stainless steel, fiberglass or plastic array, preferably polycarbonate, molded to represent an official football helmet [001] facemask [002] of same scale as previously mentioned replica helmet [001] body.
1. Purpose is for authenticity and functionality while pouring liquid.
2. The miniature football helmet [001] liquid pouring device: may also have imagery of customer's choice including but not limited to, team name, team logo, team colors, fan name and/or player face to individualize product.
3. Replica helmet [001] accessories: Purpose is to maximize authenticity of overall replica appearance. Team decals/screening/painting: used to indicate owner's favorite professional or collegiate team. The components are assembled to closely resemble an official professional or collegiate football helmet [001] but on, but not limited to, approximately one-tenth scale.
4. The hole (20) in top is slightly larger than the diameter of the tip of the liquid pourer [003] device. Helmet [001] body has interference fit for the uniquely designed liquid pourer [003] along with a pouring passage defined through said assembly for conducting liquid out from said container; the assembly is produced to be inserted into a container of liquid, held in the hand to pour for consumption.
5. On overall success of each design and upon customer desire, placing of alternate teams or images on the helmet [001] is imminent.
6. The components are assembled in a manner to duplicate an actual official helmet [001]; team decals/screening are applied in appropriate locations, facemask [002] is attached to the helmet [001] as is the liquid pouring device [003].

I claim:

1. A miniature football helmet liquid bottle pourer compromising:
a pouring assembly [003] being removably engaged to a bottle for pouring liquid from the bottle, said pouring assembly including a tubular member being removably extended in the bottle and through which liquid is passed, and also including a spout (20) having a passageway extending there through and being in operable communication to said tubular member through which liquid is poured from the bottle, and further including an air tube (22) member being disposed in said tubular member: and incorporated with a miniature replica of an official football helmet [001] with detailed color and graphics depicting the owner's favorite professional or collegiate team being in operable communication to said pouring assembly for the purpose of transporting the liquid upon being poured from the bottle, said assembly including a housing (23) being in operable communication at a bottom end of said tubular member to generally prevent spillage of the liquid from said spout, and also including an elongate air conduit member (22) being connected to said housing to aid the transport of the liquid in said spout, said housing including an upper portion and a lower portion with a partition separating said upper and lower portions and sealing said lower portion from said upper portion.
The miniature football helmet liquid bottle pourer as described in claim [0033], wherein said upper portion of said housing is attached at said bottom end of said tubular member.
The miniature football helmet liquid bottle pourer as described in claim [0034], wherein said upper portion has an open top end and has at least one side wall having at least one opening being disposed there to allow liquid from the bottle to be passed through said at least one opening and through said tubular member (20) and said spout.
The miniature football helmet liquid bottle pourer as described in claim [0034], wherein said open top end of said upper portion of said housing has an edge portion which is attached about a bottom portion of said tubular member.
The miniature football helmet liquid bottle pourer as described in claim [0035], wherein said lower portion has an air chamber (22) disposed therein.
The miniature football helmet liquid bottle pourer as described in claim [0037], wherein said lower portion also has an open bottom to facilitate cleaning of said air chamber.
The miniature football helmet liquid bottle pourer as described in claim [0038], wherein said assembly also includes a miniature replica of an official football helmet with detailed color and graphics depicting the owner's favorite professional or collegiate team.
The miniature football helmet liquid bottle pourer as described in claim [0039], wherein said assembly is removably and sealingly engaged in said open bottom of said lower portion of said housing.
The miniature football helmet liquid bottle pourer as described in claim [0040], wherein said has a small hole being disposed there through to equalize pressure in said elongate air conduit member to facilitate flow of the liquid through said at least one opening of said housing.
The miniature football helmet liquid bottle pourer as described in claim[0037], wherein said helmet assembly further includes an air tube extension being disposed in said housing and being in fluid communication with said air tube member.
The miniature football helmet liquid bottle pourer as described in claim [0042], wherein said air tube extension is disposed upon and along an inner side of said at least one side wall of said upper portion of said housing.
The miniature football helmet liquid bottle pourer as described in claim [0043], wherein said air tube extension extends through said partition and is in fluid communication with said air chamber, and in cooperation with said air tube member and said spout, passes air into said air chamber from outside the bottle.
The miniature football helmet liquid bottle pourer as described in claim [0044], wherein said elongate air conduit member extends through said partition and is in fluid communication with said air chamber, and extends into said tubular member through said bottom end thereof and is in fluid communication with said passageway of said spout for passing air from said air chamber into the liquid as the liquid is being poured from the bottle.
The miniature football helmet liquid bottle pourer as described in claim [0045], wherein said elongate air conduit member is disposed in said tubular member such that in cooperation with said air chamber, said air tube extension and said air tube member, a vacuum is formed in said air chamber after the liquid is dispensed from the bottle thus resulting in any liquid remaining in said spout being sucked back into the bottle to prevent the liquid from dripping from the spout.
A miniature football helmet liquid bottle pourer compromising:
Wherein the size of the overall device is approximately but not limited to, one tenth-scale of an official size football helmet [001], with hole in top, accessories including a facemask [003] and a uniquely designed liquid pourer [003] that is inserted and held in place in a container of liquid,
wherein liquid may exit during pouring of an inverted bottle. This helmet [001] has a uniquely designed, built in, liquid pourer [003] device incorporated in its design. This embodiment includes a replica helmet [001] body; replica facemask [002]; a built-in liquid pouring engine. This assembly is produced to be placed on a container of liquid so that the owner may enjoy their favorite professional or collegiate team while pouring their favorite beverage.
A miniature football helmet [001], wherein the size of the overall device is, but not limited to, approximately one- tenth of an official size football helmet [001], with hole in top, wherein the size of the hole is slightly larger than the diameter of the tip of the uniquely designed liquid pourer [003] device. This is a pouring passage defined through said assembly for conducting liquid out from said container; the assembly is produced to be inserted into a container of liquid held securely in place by specifically designed grips and wherein liquid may exit during pouring of the owner's inverted bottle.
The pouring passage as defined through said assembly is for conducting liquid out from said container; The replica helmet [001] of claim [0048], with replica facemask [002] includes team decals and paint screening wherein the team decals and screening are applied to the exterior of the replica helmet [001] body.
A miniature football helmet [001] with hole in top comprising a replica helmet [001] body; replica facemask [002] wherein the size of the hole is slightly larger than the diameter of the tip of the uniquely designed liquid pourer [003] device. This is a pouring passage defined through said assembly for conducting liquid out from said container; the assembly is produced to be inserted into a container of liquid held securely in place be specifically designed grips and wherein liquid may exit during pouring of the owner's inverted bottle. A pouring passage defined through said assembly for conducting liquid out from said container; this assembly is produced to closely replicate the appearance of a professional or collegiate team football helmet [001] and can be placed on a liquid container or on a surface where sports memorabilia may be displayed by owner or other user.
